(19) United States
(12) Patent Application Publication
(10) Pub. No.: US 2022/0196228 A1
(43) Pub. Date: Jun. 23, 2022

(54) LIGHT STRING INSTALLATION STRUCTURE

(71) Applicant: Dongguan City Rainmin intelligent Technology Limited, Guangdong (CN)

(72) Inventor: XIAO YAN LIU, Guangdong (CN)

(73) Assignee: Dongguan City Rainmin intelligent Technology Limited, Guangdong (CN)

(21) Appl. No.: 17/185,991

(22) Filed: Feb. 26, 2021

(30) Foreign Application Priority Data
Dec. 18, 2020 (CN) 202023064617.X
Jan. 19, 2021 (CN) 202120135756.2

(51) Int. Cl. F21V 21/088; F21S 4/10; F21S 4/28; F21V 23/06

(52) U.S. Cl. CPC F21V 21/088; F21V 23/06; F21S 4/28; F21S 4/10

(57) ABSTRACT

A light string installation structure includes a light source body, a holder and a wire. A plurality of light source bodies are provided, and are connected by the wire, and each of the light source bodies is engaged on the holder. Specifically, each light source body includes a housing and a buckle with an open end. The buckle is provided at a bottom portion of the housing, and the housing is provided with two or more coupling portions for connection with the wire. The holder is provided with a clamping strip matching the buckle, and the buckle is fastened to and fixed on the clamping strip. When the holder is fixed at a position as required, the light source bodies can be disassembled and replaced separately.

### CROSS-REFERENCE TO RELATED APPLICATION

This application claims the priority benefit of China application serial no. 202023064617.X, filed on Dec. 18, 2020 and China application serial no. 202120135756.2, filed on Jan. 19, 2021. The entirety of each of the above-mentioned patent applications is hereby incorporated by reference herein and made a part of this specification.

### BACKGROUND

### Field of the Disclosure

The disclosure relates to the technical field of light string installation, in particular to a light string installation structure.

### Description of Related Art

LED light string is typically composed of a light source body and a wire. The wire connects multiple light source bodies into a string to form a light string. During the installation process of the LED light string, screws or binding are commonly adopted to fix multiple light source bodies, so as to arrange the LED light string at the light-emitting path as required. Alternatively, the light source bodies are embedded in a recess to fix each of the light source bodies, such that the LED light string is arranged linearly. When it is required to replace a light source body among the LED light string, the disassembly and assembly operations required for the former configuration is complicated. For the latter configuration, it is required to remove the whole LED light string from where it is fixed and arranged, and the new light source body is arranged again after the old one is replaced, which causes a lot of inconvenience in actual application.

### SUMMARY OF THE DISCLOSURE

The purpose of the disclosure is to provide a light string installation structure. When the holder is fixed at a required position, the light source bodies can be disassembled and replaced separately, and only a little force is required during installation/disassembly to push in/pull out the light source bodies. The operation is easy and the structure is simple.

In order to achieve the above purpose, the disclosure provides the following technical solutions.

A light string installation structure includes a plurality of light source bodies, a holder and a wire. The light source bodies are connected by the wire, and each of the light source bodies is engaged on the holder. Each of the light source bodies includes a housing and a buckle having an open end. The buckle is provided at a bottom portion of the housing, and the housing is provided with two or more coupling portions for connection with wires, so that the wire is connected to the coupling portions. The holder is provided with a clamping strip matching the buckle, and the buckle is detachably fastened to and fixed on the clamping strip.

In one of the embodiments, the buckle is bent inward at the open end to form a buckle portion being elastic and surrounding a buckle space. The clamping strip includes a curved surface portion and a protruding portion matching the buckle portion and engaging the buckle space. The curved surface portion is engaged with the buckle, and the buckle portion is engaged with the protruding portion.

In one of the embodiments, the two end portions of the buckle are bent and each of the end portions is formed with an inclined portion, and the inclined portion is inclined in a direction opposite to the bending direction.

In one of the embodiments, each of the light source bodies further includes a light source installation cavity, the two coupling portions are respectively located on two sides of the light source installation cavity, and the coupling portions are detachably connected to the wire.

In one of the embodiments, an anti-slip tape is provided on both sides of an inner wall of each of the coupling portions, and the anti-slip tapes on both sides are arranged at intervals.

In one of the embodiments, the housing is a transparent or translucent housing, and the housing is rectangular-shaped with chamfers or is arched-shaped.

In the light string installation structure provided in the disclosure, when the holder is fixed at a required position, the buckle of the light source bodies connected through the wire is fastened to and fixed on the clamping strip on the holder, thereby fixing the light source body with the holder, and realizing installation of the LED light string. The light source bodies can be disassembled and replaced separately, and only a little force is required during installation/disassembly to push in/pull out the light source bodies. The operation is easy and the structure is simple.

### BRIEF DESCRIPTION OF THE DRAWINGS

FIG. 1 is a perspective view of the overall structure of a light string installation structure in an embodiment.

FIG. 2 is a side view of FIG. 1.

FIG. 3 is a schematic view of the structure of the light source body in FIG. 1.

FIG. 4 is a schematic view of the structure in a second embodiment.

### DESCRIPTION OF EMBODIMENTS

The following will explicitly and thoroughly describes the technical solutions in the embodiments of the disclosure in conjunction with the accompanying drawings in the embodiments of the disclosure. Clearly, the described embodiments are only a part of the embodiments of the disclosure, but not all the embodiments. Based on the embodiments of the disclosure, all other embodiments obtained by those of ordinary skill in the art without making inventive effort shall fall within the scope of the disclosure.

### First Embodiment

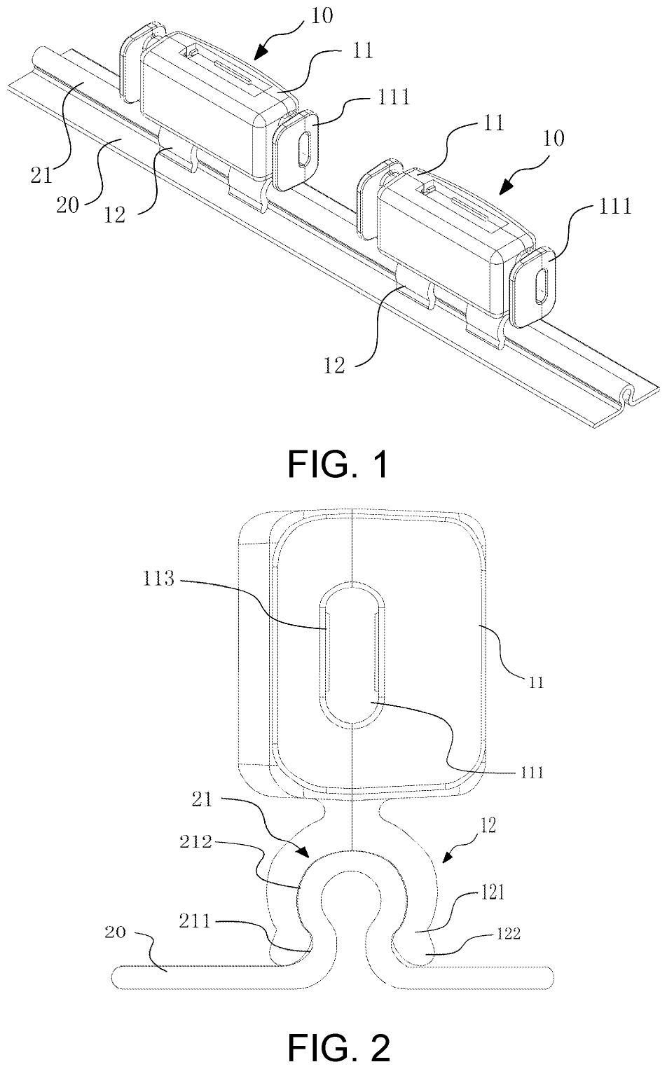

FIG. 1 is a perspective view of the overall structure of a light string installation structure in an embodiment. The light string installation structure includes a plurality of light source bodies 10, a holder 20 and a wire (not shown in the figure). The light source bodies 10 are connected through the wires, and each of the light source bodies 10 is engaged on the holder 20. Specifically, the light source body 10 includes a housing 11 and a buckle 12 having an open end. The housing 11 is rectangular-shaped with chamfers. A shape of the housing 11 can be selected according to specific needs, and is not limited in the disclosure. For example, the housing 11 can also be arched-shaped. The buckle 12 is arranged at a bottom portion of the housing 11, and the housing 11 is provided with two or more coupling portions 111 for connection with wires, and the wires are connected to the coupling portions 111. Preferably, the housing 11 is a transparent or translucent housing, and each of the light source bodies 10 includes two buckles 12. In other embodiments, the housing 11 may also be a housing of other colors or materials. Each of the light source bodies 10 may also include one or more than two buckles 12. The holder 20 is provided with a clamping strip 21 matching the buckle 12, and the buckle 12 is detachably fastened to and fixed on the clamping strip 21. In this embodiment, the clamping strip 21 and the holder 20 are integrally formed. In other embodiments, the clamping strip 21 and the holder 20 can be connected and fixed in other ways.

When in use, the holder 20 is first fixed at a position as required, and the buckle 12 of the light source body 10 connected by the wire are fastened to and fixed on the clamping strip 21 on the holder 20, thus the light source body 10 is fixed with the holder 20, and realizing installation of the LED light string.

Specifically, as shown in FIG. 2, the buckle 12 is bent inward at the open end to form a buckle portion 121 being elastic. The buckle portion 121 surrounds a buckle space. The clamping strip 21 includes a curved surface portion 211 and a protruding portion 212 matching the buckle portion 121 and engaging the buckle space. The curved surface portion 211 is engaged with the buckle 12, and the buckle portion 121 is engaged with the protruding portion 212. Preferably, two end portions of the buckle 21 are bent and each of the end portions is formed with an inclined portion 122. The inclined portion 122 is inclined in a direction opposite to a bending direction. During installation, the buckle 12 is aligned with the clamping strip 21 and is pressed. Under the circumstances, the buckle portion 121 is in contact with the curved surface portion 211, and a tension of the buckle portion 121 is applied so that the buckle portion 121 slides along the curved surface portion 211 toward the protruding portion 212 until the buckle portion 121 is restored under the effect of elastic force and fastened to the protruding portion 212. When the buckle portion 121 slides along the curved surface portion 211 toward the protruding portion 212, the inclined portion 122 allows the tension of the buckle portion 121 to be quickly applied even if the buckle 12 is not accurately aligned with the clamping strip 21, and the buckle 12 can be successfully engaged with the clamping strip 21. In this embodiment, the surface of the inclined portion 122 is a frosted surface, which can increase the frictional force after the buckle 12 is engaged with the clamping strip 21, so that the light source body 10 does not slip along the clamping strip 21 when no external force is applied.

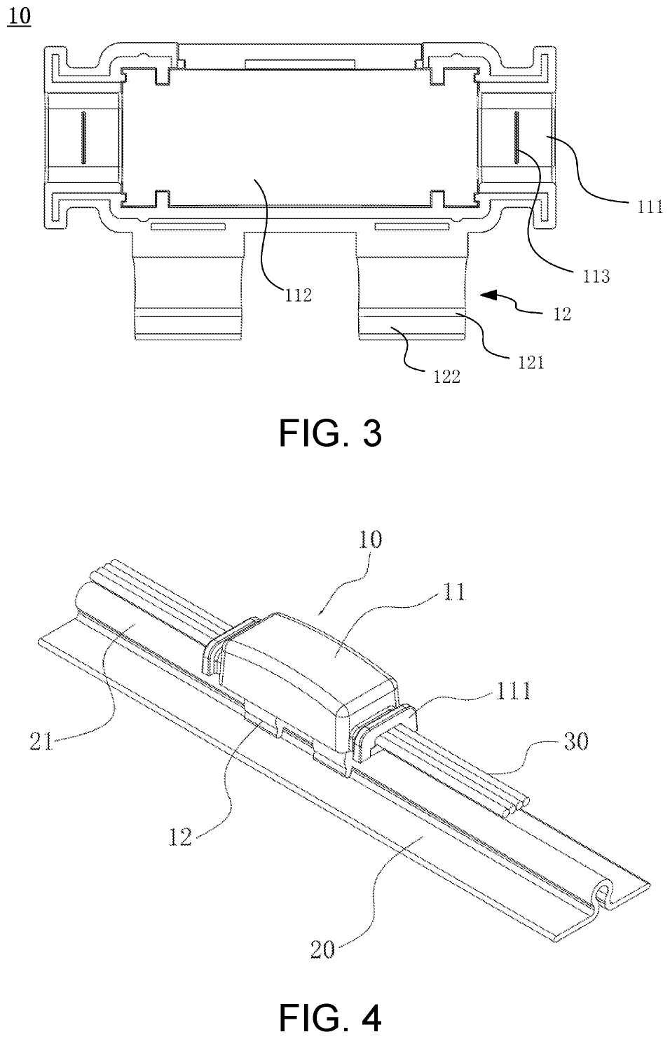

In an embodiment, as shown in FIG. 3, the light source body 10 includes a light source installation cavity 112 and two coupling couplings 111, and the two coupling couplings 111 are respectively located on both sides of the light source installation cavity 112. The coupling couplings 111 are fixedly connected to the wire (not shown in the figure). Preferably, in another embodiment, the coupling couplings 111 are detachably connected to the wire, which makes it easier to replace a single light source body 10. Specifically, the anti-slip tape 113 can be arranged on both sides of an inner wall of the coupling couplings 111, and the anti-slip tape 113 on both sides are arranged at intervals to prevent the wires from falling off.

In the light string installation structure of the disclosure, when the holder 20 is fixed at the position as required, the buckle 12 in the light source bodies 10 connected through the wire (not shown in the figure) is fastened to and fixed on the clamping strip 21 on the holder 20, thus the light source body 10 is fixed with the holder 20, and realizing installation of the LED light string. The light source bodies 10 can be disassembled and replaced separately, and only a little force is required during installation/disassembly to push in/pull out the light source bodies. The operation is easy and the structure is simple.

### Second Embodiment

In this embodiment, the housing 11 is arched-shaped, which is convenient for installation and can save space. The coupling portion 111 is set horizontally, and the coupling portion 111 is connected with a wire 30, and the wire 30 is connected to the light source body 10. Other structures in this embodiment are the same as those in the first embodiment.

The above examples only show several preferred embodiments of the disclosure. The description of the examples is relatively specific and detailed. It should be understood that the disclosure is not limited to the form disclosed herein, and should not be construed as an exclusion of other embodiments, but can be used in various other combinations, modifications, and environments, and can be modified in the scope of the disclosure through the above teaching as well as skills or knowledge in the related field, and therefore should not be construed as a limitation to the disclosure. It should be pointed out that for those of ordinary skill in the art, without departing from the concept of the disclosure, several modifications and improvements can be made to the disclosure, and the modifications and changes made by persons skilled in the art do not deviate from the spirit and scope of the disclosure, and all belong to the scope sought to be protected by the appended claims of the disclosure. Therefore, the scope of the disclosure should be subject to the appended claims.

What is claimed is:

1. A light string installation structure, comprising a plurality of light source bodies, a holder and a wire, wherein the plurality of light source bodies are connected by the wire, and each of the plurality of light source bodies is engagingly disposed on the holder,
wherein each of the light source bodies comprises a housing and a buckle having an open end, the buckle is provided at a bottom portion of the housing, and the housing is provided with two or more coupling portions for connection with the wire, and the wire is connected to the coupling portions, the holder is provided with a clamping strip matching the buckle, and the buckle is detachably fastened to and fixed on the clamping strip.

2. The light string installation structure according to claim 1, wherein the buckle is bent inward at the open end to form a buckle portion being elastic and surrounding a buckle space, the clamping strip comprises a curved surface portion and a protruding portion matching the buckle portion and engaging the buckle space, the curved surface portion is engaged with the buckle, and the buckle portion is engaged with the protruding portion.

3. The light string installation structure according to claim 2, wherein two end portions of the buckle are bent and each of the end portions is formed with an inclined portion, and the inclined portion is inclined in a direction opposite to a bending direction.

4. The light string installation structure according to claim 1, wherein each of the light source bodies further comprises a light source installation cavity, the two coupling portions are respectively located on two sides of the light source installation cavity, and the coupling portions are detachably connected to the wire.

5. The light string installation structure according to claim 4, wherein an anti-slip tape is provided on both sides of an inner wall of each of the coupling portions, and the anti-slip tapes on the both sides are arranged at intervals.

6. The light string installation structure according to claim 1, wherein the housing is a transparent or translucent housing, and the housing is rectangular-shaped with chamfers or is arched-shaped.
